(19) United States
(12) Patent Application Publication
(10) Pub. No.: US 2024/0021804 A1
(43) Pub. Date: Jan. 18, 2024

(54) ENERGY STORAGE DEVICE, SILICON ANODE, AND POLYMER ELECTROLYTE

(71) Applicant: The Johns Hopkins University, Baltimore, MD (US)

(72) Inventors: Konstantinos Gerasopoulos, Highland, MD (US); Matthew W. Logan, Columbia, MD (US); Bing Tan, Ann Arbor, MI (US)

(21) Appl. No.: 17/865,867

(22) Filed: Jul. 15, 2022

(51) Int. Cl. H01M 4/38; H01M 4/587; H01M 4/62; H01M 10/0565; H01M 4/134; H01M 4/133

(52) U.S. Cl. CPC H01M 4/386; H01M 4/587; H01M 4/622; H01M 10/0565; H01M 4/134; H01M 4/133; H01M 2300/0082; H01M 2004/021

(57) ABSTRACT

Aspects of the disclosure describe an energy storage device comprising a cathode, an anode, a separator, and an electrolyte. The anode comprises a support structure and an electrode layer disposed on the support structure. The electrode layer comprises 40-80% silicon, 15-40% graphite, 5-15% carbon black, 0-15% carboxymethyl cellulose (CMC), 0-5% styrene-butadiene rubber (SBR), and 5-20% poly(acrylic acid). The separator is disposed between the anode and cathode to prevent internal shorting of the energy storage device. The electrolyte allows movement of ions between the anode and cathode.

### STATEMENT REGARDING FEDERALLY SPONSORED RESEARCH OR DEVELOPMENT

This invention was made with Government support under Contract No. N00024-13-D-6400 awarded by the United States Department of the Navy. The Government has certain rights in the invention.

### TECHNICAL FIELD

The present disclosure relates to electrical energy storage devices, for example, anodes, cathodes, and electrolytes used in energy storage devices (e.g., lithium ion batteries).

### BACKGROUND

In the state of the art, energy storage devices such as batteries commonly use graphite-based electrodes. A problem is that such state of the art batteries have reached their limits in terms of specific energy and/or energy density. There is a growing interest in methods to increase specific energy and energy density of batteries. A battery can include several elements, including cathodes, anodes, electrolyte, or the like. Attempts to increase specific energy and energy density can be possible by developing new cathodes, anodes, or even exploring completely different materials. Silicon is a relatively new material to be considered for electrodes. Some research has been done on silicon electrodes in the past, but silicon-electrode batteries have drawbacks that prevent widespread commercial use. Silicone can result in very high capacity—about 3000-3600 mAh/g specific capacity, almost 10× higher than graphite that is used in commercial batteries today (e.g., ˜360 mAh/g for graphite).

However, silicon electrodes are prone to volume expansion during use. As the volume expands and contracts, the material of the electrode can break. The breakage can cause electrode material to lose contact from the electrode. Consequently, the specific capacity of the battery can decay.

### SUMMARY

Accordingly, it is desirable to solve the issues of silicon-based electrodes used in energy storage devices.

In some aspects, an energy storage device can comprise a cathode, an anode, a separator, and an electrolyte. The anode can comprise a support structure and an electrode layer disposed on the support structure. The electrode layer can comprise 40-80% silicon, 15-40% graphite, 5-15% carbon black, 0-15% carboxymethyl cellulose (CMC), 0-5% styrene-butadiene rubber (SBR), and 5-20% poly(acrylic acid). The separator can be disposed between the anode and cathode to prevent internal shorting of the energy storage device. The electrolyte can allow movement of ions between the anode and cathode.

In some aspects, an electrode can comprise a support structure and an electrode layer disposed on the support structure. The electrode layer can comprise 40-80% silicon, 15-40% graphite, 5-15% carbon black, 0-15% carboxymethyl cellulose (CMC), 0-5% styrene-butadiene rubber (SBR), and 5-20% poly(acrylic acid).

In some aspects, a polymer electrolyte can comprise 90-98% poly(ethylene glycol) methyl ether acrylate (MPEGA), 2-10% polyethylene glycol diacrylate (PEGDA), and lithium hexafluorophosphate (LiPF6). The LiPF6 can be prepared in a mixture comprising bis(2,2,2-trifluoroethyl) ether (BTFE), and at least one of ethylene carbonate (EC), dimethyl carbonate (DMC), diethyl carbonate (DEC), triethyl phosphate (TEP), and fluoroethylene carbonate (FEC).

Further features of the present disclosure, as well as the structure and operation of various aspects, are described in detail below with reference to the accompanying drawings. It is noted that the present disclosure is not limited to the specific aspects described herein. Such aspects are presented for illustrative purposes only. Additional aspects will be apparent to persons skilled in the relevant art(s) based on the aspects described herein.

### BRIEF DESCRIPTION OF THE DRAWINGS/FIGURES

The accompanying drawings, which are incorporated herein and form part of the specification, illustrate the present disclosure and, together with the description, further serve to explain the principles of the present disclosure and to enable a person skilled in the relevant art(s) to make and use aspects described herein.

FIG. 1 shows an energy storage device, according to some aspects.

FIGS. 2-8 show graph plots of measurements with respect to discharge/charge cycles, according to some aspects.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

This specification discloses one or more aspects that incorporate the features of the present disclosure. The disclosed aspect(s) are provided as examples. The scope of the present disclosure is not limited to the disclosed aspect(s). Claimed features are defined by the claims appended hereto.

The aspect(s) described, and references in the specification to “one aspect,” “an aspect,” “an exemplary aspect,” “an example aspect,” etc., indicate that the aspect(s) described can include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of one skilled in the art to effect such feature, structure, or characteristic in connection with other aspects whether or not explicitly described.

Spatially relative terms, such as “beneath,” “below,” “lower,” “above,” “on,” “upper” and the like, can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly.

The term “about.” “approximately,” or the like can be used herein to indicate a value of a quantity that can vary or be found to be within a range of values, based on a particular technology. Based on the particular technology, the terms can indicate a value of a given quantity that is within, for example, 1-20% of the value (e.g., ±1%, ±5% ±10%, ±15%, or ±20% of the value).

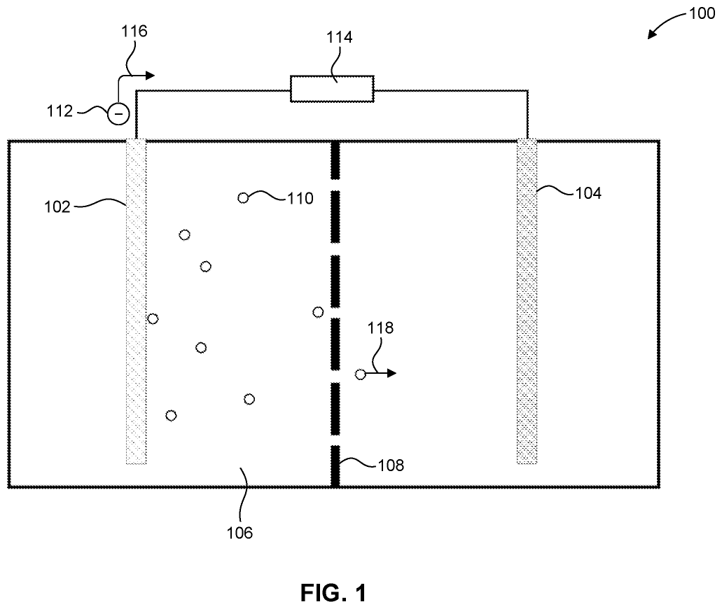

FIG. 1 shows an energy storage device 100, according to some aspects. Those skilled in the art will appreciate that, in some aspects, the drawing in FIG. 1 can be referred to as a cell diagram of energy storage device 100 (or full cell, as opposed to half-cell). In some aspects, energy storage device 100 can comprise an anode 102, a cathode 104, an electrolyte 106, a separator 108, and ions 110. The term “electrode” can be used herein to refer to an anode or a cathode. For example, anode 102 can be an electrode that releases electrons 112 when a circuit is completed between anode 102 and cathode 104 via load 114. Anode 102 can comprise a layered structure (e.g., a metal foil coated with an active material, aluminum foil coated with anode active material, or the like). Cathode 104 can comprise a layered structure (e.g., a metal foil coated with an active material, copper foil coated with cathode active material, or the like). Electrolyte 106 can comprise a medium that allows the movement of ions 110 between anode 102 and cathode 104. Separator 108 can comprise a permeable membrane to separate anode 102 and cathode 104 so as to prevent electrical shorting between anode 102 and cathode 104. Separator 108 can be porous. The permeability of separator 108 can allow ions 110 to move between anode 102 and cathode 104. In some aspects, ions 110 can comprise lithium, zinc, sodium, potassium, or the like.

In some aspects, an operation illustrated in FIG. 1 is that of discharging energy storage device 100. For example, a direction of current flow 116 indicates a discharging of energy storage device 100 from a high energy state to a low energy state. Similarly, a direction of ion flow 118 indicates a discharging of energy storage device 100 from a high energy state to a low energy state. It should be appreciated that a charging operation can reverse the directions of the current flows.

In some aspects, electrolyte 106 can comprise a liquid medium. For example, a liquid electrolyte can allow case of ion flow 118 with low resistance (e.g., high ion conductivity). In some aspects, electrolyte 106 can comprise a non-liquid medium (e.g., a gel polymer medium, a solid-state medium, or the like).

In some aspects, anode 102 and/or cathode 104 can comprise silicon material. Some potential problems with silicon-based electrodes have been described above (e.g., severe volume expansion/contraction and material detaching from electrodes). The inventors have identified solutions that mitigate issues of silicon-base electrodes, thereby allowing practical implementation of silicon-based electrodes in energy storage device 100. Aspects described herein include various silicon compositions for electrodes from experimental studies.

In some aspects, the term “specific” as used in, for example, “specific energy” or “specific capacity.” can be used to characterize a mass-referenced quantity. For example, “specific energy” can refer to an energy per unit mass of a material or object (e.g., J/kg, Wh/kg, mWh/g, or the like). The term “specific density” can be used to characterize a volume-referenced quantity. For example, “energy density” can refer to an energy per unit volume of a material or object (e.g., J/m³, Wh/L, or the like). Furthermore, where specified, density can also characterize a quantity per unit area or a quantity unit length.

In some aspects, silicon can have a much higher energy density than graphite. That is, a silicon electrode can store significantly more energy than a graphite electrode of the same mass.

In some aspects, graphite electrodes typically operate by ion intercalation. For example, intercalation is the reversible inclusion or insertion of a molecule (or ion) into layered materials with layered structures (e.g., a layer of carbon, such as graphite). While the intercalation process can cause the graphite material to expand and contract, the change in volume can be subdued when compared to when ions are inserted into a silicon electrode. The silicon material of an electrode can expand by as much as 300% when injected with ions. The expansion of silicon electrodes can be due to, for example, an operating principle that is different from the ion intercalation of graphite.

In some aspects, in silicon electrodes, lithium silicide is formed when lithium ions meet the silicon electrode. The large volume expansion (and contraction when ion insertion is reversed) can cause the electrode material to develop breaks. As the material becomes damaged, it can lose contact with the conductive additive that helps electrons flow from the electrode's active material to an external device seeking to be powered. Consequently, the storage capacity of the energy storage system decays because of the damage to the electrode material.

In some aspects, an electrode combines silicon and graphite material to achieve some of the energy storage capabilities of silicon, while mitigating the volume expansion and contraction it brings along with it.

Tables 1A and 1B below show measured performance data for some of the compositions (or formulation) of anode 102 (or cathode 104) to test the effects of silicon particle size, according to some aspects.

TABLE 1A
Measurements of Electrode Compositions (Effect of Particle Size)

| Si | | | Active | |
|---|---|---|---|---|
| Particle | | Sample ID and Electrode | Loading | Current |
| Size | | Composition (by mass ratio) | (mg/cm²) | (mA/cm²) |
| 45 | μm | A: 75% Si/10% C65/10% PAL/ | 1.77 | 0.57 |
| | | 2.5% CMC/2.5% SBR | | |
| 45 | μm | B: 75% Si/10% C65/10% PAL/ | 3.45 | 0.57 |
| | | 2.5% CMC/2.5% SBR | | |
| 3 | μm | C: 60% Si/15% graphite/10% | 0.83 | 0.8 |
| | | C65/10% PAL/2.5% CMC/2.5% SBR | | |
| 3 | μm | D: 60% Si/15% graphite/10% | 0.80 | 0.03 |
| | | C65/10% PAL/2.5% CMC/2.5% SBR | | |
| 100 | nm | E: 75% Si/10% C65/10% PAL/ | 1.70 | 0.19 |
| | | 2.5% CMC/2.5% SBR | | |
| 100 | nm | F: 75% Si/10% C65/10% PAL/ | 1.88 | 0.19 |
| | | 2.5% CMC/2.5% SBR | | |

TABLE 1B
Measurements of Electrode Compositions (Effect of Particle Size)

| Si | | | 1^{st} | | 1^{st} discharge | 1^{st} charge | |
|---|---|---|---|---|---|---|---|
| Average | | | discharge | 1^{st} charge | specific | specific | 1^{st} Cycle |
| Particle | | | capacity | capacity | capacity | capacity | Coulombic |
| Size | | Sample ID | (mAh) | (mAh) | (mAh/g) | (mAh/g) | Efficiency |
| 45 | μm | A | 8.92 | 4.6 | 3268 | 1680 | 51.4% |
| 45 | μm | B | 17.23 | 4.85 | 3244 | 914 | 28.2% |
| 3 | μm | C | 4.55 | 2.66 | 3582 | 2091 | 58.4% |
| 3 | μm | D | N/A | 2.62 | N/A | 2120 | N/A |
| 100 | nm | E | 7.85 | 2.27 | 3008 | 869 | 28.9% |
| 100 | nm | F | 6.93 | 2.39 | 2397 | 828 | 34.5% |

In some aspects, the tests conducted for Tables 1A and 1B concerned the effects of silicon particle size. Some of the commercial silicon products were prepared using 325 mesh, which is a fine size U.S. Standard mesh size with a 45 μm sieve opening (resulting particle size is approximately 45 μm on average). Furthermore, the tests performed for Tables 1A and 1B were performed in coin half-cells. A half-cell is a setup that can be used for testing electrode performance. A half-cell can include the electrode-under-test (sample), a reference electrode, and a counter electrode). In a half-cell that uses lithium as the mobile ions, lithiation (e.g., the incorporation of lithium into an electrode) can correspond to a discharge operation for the half-cell. Electrode compositions included materials such as silicon (“Si”), carbon black C65 (“C65”) (a conductive additive for battery cathodes and anodes), lithiated poly(acrylic acid) (“PAL”), carboxymethyl cellulose (“CMC”) binder, styrene-butadiene rubber (SBR), and/or graphite. Electrode compositions in Tables 1A and 1B are also labeled A-F for convenient referencing. It is to envisaged that silicon particle sizes can be implemented with an average size of 45 μm or less, 3 μm or less, or 100 nm or less.

In some aspects, the term “active loading” can be used herein to refer to active material loading, which is the mass (or normalized mass) of the components of the electrode formulation that facilitate ion reactions (e.g., Li+ reactions). In some non-limiting examples, active material loading can refer to silicon-only, silicon and graphite, or the like. Active loading can be expressed in mass per unit area or volume (e.g., mg/cm²). In one non-limiting example, active loading of electrode samples disclosed herein can be approximately 1-5 mg/cm². In some aspects the electrical current data provided in tables herein can be expressed in current per unit area (e.g., mA/cm²) of a planar portion of the half-cell or full cell devices (the devices can be fabricated as a planar structure).

In some aspects, Coulombic efficiency (“CE”) in Table 1B can refer to a ratio of how much energy is extracted from an electrode versus how much energy was provided to the electrode. CE can also be referred to as reversible capacity. Instances for which data was not available are marked as N/A. In some aspects, the measurements designated by the qualifier “1^{st}” can refer to the first measurements performed after fabrication of the cell and having no prior history of charging/discharging since the cell was fabricated (e.g., 1^{st} discharge, 1^{st} charge, 1^{st} cycle CE, or the like). It is noted that the 1st discharge specific capacity is generally greater than 3000 mAh/g for most samples. The highest discharge specific capacity was attained by sample C with 3 um Si combined with 15% graphite. The highest CE was attained also by Sample C. The tests show that smaller particle sizes did not appear to have significant impact to 1^{st} cycle CE. However, other tests with different configurations were able to illicit the expected behavior from the smaller particles (e.g., as shown in Tables 6A and 6B).

Table 2 below shows measured performance data for some of the compositions of anode 102 (or cathode 104) to test the effects of mass loading rate and charge/discharge current, according to some aspects.

TABLE 2
Measurements of Electrode Compositions (Effect
of Mass Loading and Charge/Discharge Current)

| | | | | 1^{st} Discharge | 1^{st} Charge | |
|---|---|---|---|---|---|---|
| | Active | Discharge | Charge | Specific | Specific | 1^{st} Cycle |
| Sample | Loading | Current | Current | Capacity | Capacity | Coulombic |
| ID | (mg/cm²) | (mA/cm²) | (mA/cm²) | (mAh/g) | (mAh/g) | Efficiency |
| A | 1.77 | 0.57 | 0.57 | 3268 | 1680 | 51.4% |
| B | 3.45 | 0.57 | 0.57 | 3244 | 914 | 28.2% |
| C | 3.33 | 0.52 | 1.09 | 3227 | 768 | 24.0% |
| D | 3.31 | 0.21 | 1.09 | 3242 | 790 | 24.4% |
| E | 3.35 | 0.11 | 1.09 | 3246 | 775 | 23.9% |
| F | 3.43 | 0.11 | 0.11 | 3109 | 545 | 17.5% |

In some aspects, the tests conducted for Table 2 concerned the effects of mass loading, discharge rates, and charge rates. Samples in Table 2 all used an electrode composition of 75% Si/10% C65/10% PAL/2.5% CMC/2.5% SBR as the baseline, but with different mass loading. The silicon particle size for samples A-F was from the 325 mesh batch (˜45 μm). The cells were half-cells. Samples A and B in Table 2 correspond to Samples A and B of Tables 1A and 1B. Samples A and B have different mass loading while holding discharge/charge rates constant or similar. Sample A with a lower mass loading exhibited a higher reversible capacity than Sample B with a higher mass loading.

In some aspects, Samples C, D and E compared the effects of different discharge rates while holding charge rates and mass loading constant or similar. Different discharge rates appeared to have no effect.

In some aspects, Samples B and C compared the effects of different charge rates while holding discharge rates and mass loading constant or similar. Different charge rates appeared to have no effect. In a similar test, Samples E and F compared the effects of different charge rates while holding discharge rates and mass loading constant or similar. In this case, however, the 1^{st} cycle CE for Sample F was noticeably reduced to 17.5%.

Tables 3A and 3B below show measured performance data for some of the compositions of anode 102 (or cathode 104) to test the effects of cell format, according to some aspects.

TABLE 3A
Measurements of Electrode Compositions (Effect of Cell Format)

| | | | | 1^{st} | 1^{st} |
|---|---|---|---|---|---|
| | Active | Discharge | Charge | Discharge | Charge |
| | Loading | Current | Current | Capacity | Capacity |
| Sample ID | (mg/cm²) | (mA/cm²) | (mA/cm²) | (mAh) | (mAh) |
| A | 1.75 | 0.10 | 0.10 | 10.7 | 8.8 |
| B | 3.43 | 0.11 | 0.11 | 16.4 | 2.9 |

TABLE 3B
Measurements of Electrode Compositions (Effect of Cell Format)

| | 1^{st} | 1^{st} | |
|---|---|---|---|
| | Discharge | Charge | 1^{st} |
| | Specific | Specific | Cycle |
| | Capacity | Capacity | Coulombic |
| Sample ID | (mAh/g) | mAh/g | Efficiency |
| A | 3963 | 3270 | 82.2% |
| B | 3109 | 545 | 17.5% |

In some aspects, the tests conducted for Tables 3A and 3B concerned the effects of cell format (e.g., coin half-cell versus pouch half-cell). Samples in Tables 3A and 3B all used an electrode composition of 75% Si/10% C65/10% PAL/2.5% CMC/2.5% SBR as the baseline, but with different cell format. The silicon was from the 325 mesh batch (particle size ˜45 μm) for Samples A and B. The cells were half-cells. Sample B in Tables 3A and 3B corresponds to Samples F of Tables 2A and 2B. Sample A with a coin half-cell format exhibited a high 1^{st} cycle CE of about 82.2%. Sample A, as before, had a 1^{st} cycle CE of about 17.5%. The coin half-cell format can provide a higher pressure to the electrode than the pouch format. During lithiation/discharge in a half-cell, the electrode material can become loose and lose electrical contact. With high cell pressure, the expansion can be mitigated and the electric contacts can be improved.

Tables 4A and 4B below show measured performance data for some of the compositions of anode 102 (or cathode 104) to test the effects of cell pressure, according to some aspects.

TABLE 4A
Measurements of Electrode Compositions (Effect of Cell Pressure)

| | | | | 1^{st} | 1^{st} |
|---|---|---|---|---|---|
| | Active | Clamping | | Discharge | Charge |
| | Loading | Pressure | Current | Capacity | Capacity |
| Sample ID | (mg/cm²) | Type | (mA/cm²) | (mAh) | (mAh) |
| A | 0.80 | paper clip | 0.13 | 4.87 | 0.58 |
| B | 0.80 | C-Clamp | 0.13 | 3.98 | 3.16 |

TABLE 4B
Measurements of Electrode Compositions (Effect of Cell Pressure)

| | 1^{st} | 1^{st} | |
|---|---|---|---|
| | Discharge | Charge | 1^{st} |
| | Specific | Specific | Cycle |
| | Capacity | Capacity | Coulombic |
| Sample ID | (mAh/g) | (mAh/g) | Efficiency |
| A | 4196 | 1294 | 30.8% |
| B | 3433 | 2727 | 79.4% |

In some aspects, the tests conducted for Tables 4A and 4B concerned the effects of cell pressure. Samples in Tables 4A and 4B all used an electrode composition of 60% Si/15% graphite/10% C65/10% PAL/2.5% CMC/2.5% SBR as the baseline, but with cell pressure (e.g., paper clip versus C-clamp). The silicon particle size was ˜3 μm for Samples A and B. The cells were half-cells. Sample B with a high pressure C-clamp exhibited a high 1^{st} cycle CE of about 79.42%. Sample B with a low pressure paper clip, on the other hand, exhibited a low 1^{st} cycle CE of about 30.8%. While high pressure exhibits better performance in terms of reversibility, high pressure can be impractical in some applications. It is desirable to have additional recourse for increasing CE, for example, by exploring different binder substances, or the like.

Tables 5A and 5B below show measured performance data for some of the compositions of anode 102 (or cathode 104) to test the effects of binder content, according to some aspects.

TABLE 5A
Measurements of Electrode Compositions (Effect of the Binder)

| | Active | Active | |
|---|---|---|---|
| Sample ID and Electrode | Loading | Loading | Current |
| Composition (by mass ratio) | (mg/cm²) | (mg/cm²) | (mA/cm²) |
| A: 60% Si/15% graphite/10% | 0.82 | 0.82 | 0.08 |
| C65/15% CMC | | | |
| B: 60% Si/15% graphite/10% | 0.83 | 0.83 | 0.08 |
| C65/10% PAL/2.5% CMC/2.5% SBR | | | |

TABLE 5B
Measurements of Electrode Compositions (Effect of the Binder)

| | | | 1^{st} | 1^{st} | |
|---|---|---|---|---|---|
| | 1^{st} | 1^{st} | Discharge | Charge | 1^{st} |
| | Discharge | Charge | Specific | Specific | Cycle |
| | Capacity | Capacity | Capacity | Capacity | Coulombic |
| Sample ID | (mAh) | (mAh) | (mAh/g) | (mAh/g) | Efficiency |
| A | 4.07 | 0.79 | 3215 | 624 | 19.4% |
| B | 4.55 | 2.66 | 3580 | 2093 | 58.5% |

The silicon particle size was ˜3 μm for Samples A and B. The cells were half-cells. In some aspects, Sample B with a combination of PAL/CMC/SBR binders exhibited a higher 1^{st} cycle CE of about 58.5% compared to sample A with only CMC binder and a 1^{st} cycle CE of about 30.8%.

In some aspects, based on the tests disclosed above, loose electrical contacts after lithiation can result in low CE. As before, it is desirable to have additional recourse for increasing CE, for example, by exploring different compositions of silicon and graphite content, or the like.

Tables 6A and 6B below show measured performance data for some of the compositions of anode 102 (or cathode 104) to test the effects of electrode compositions with silicon and graphite, according to some aspects.

TABLE 6A
Measurements of Electrode Compositions
(Effect of Added Graphite)

| | Active | |
|---|---|---|
| Sample ID and Electrode | Loading | Current |
| Composition (by mass ratio) | (mg/cm²) | (mA/cm²) |
| A: 75% Si/10% C65/10% PAL/2.5% | 1.70 | 0.19 |
| CMC/2.5% SBR | | |
| B: 42.5% Si/32.5% graphite/10% | 3.24 | 0.33 |
| C65/10% PAL/2.5% CMC/2.5% SBR | | |
| C: 42.5% Si/32.5% graphite/10% | 3.01 | 0.33 |
| C65/10% PAL/2.5% CMC/2.5% SBR | | |

TABLE 6B
Measurements of Electrode Compositions
(Effect of Added Graphite)

| | | | 1^{st} | 1^{st} | |
|---|---|---|---|---|---|
| | 1^{st} | 1^{st} | Discharge | Charge | 1^{st} |
| | Discharge | Charge | Specific | Specific | Cycle |
| | Capacity | Capacity | Capacity | Capacity | Coulombic |
| Sample ID | (mAh) | (mAh) | (mAh/g) | (mAh/g) | Efficiency |
| A | 7.85 | 2.27 | 3008 | 869 | 28.9% |
| B | 5.59 | 4.59 | 1725 | 1417 | 82.1% |
| C | 6.17 | 4.97 | 2050 | 1652 | 80.6% |

The silicon particle size was ˜100 nm for Samples A-C. The cells were half-cells. In some aspects, the data in Tables 6A and 6B shows that the added graphite increased the 1^{st} cycle CE from about 28.9% to greater than 80%.

In some aspects, a ratio of the anode-to-cathode capacities in full cells can also influence the effectiveness of different electrode performance. The active loading of the anode can affect the capacity of the anode while the active loading of the cathode can affect the capacity of the cathode. The full cell cathode can be made of, for example, lithium nickel cobalt aluminum oxide (NCA). Tables 7A and 7B below show measured performance data for some of the compositions of anode 102 (or cathode 104) to test the effects of anode loading in full cells with NCA, according to some aspects.

TABLE 7A
Measurements of Full Cells (Effect of
Anode Loading in Full Cells with NCA)

| | | Anode |
|---|---|---|
| | | Active |
| | | Loading |
| Sample ID | Electrolyte | (mg/cm²) |
| A | 0.9M LiPF6 in EC/DMC (3/7), 10 wt % FEC | 4.7 |
| B | 0.9M LiPF6 in EC/DMC (3/7), 10 wt % FEC | 4.7 |
| C | 0.9M LiPF6 in EC/DMC (3/7), 10 wt % FEC | 3.1 |
| D | 0.9M LiPF6 in EC/DMC (3/7), 10 wt % FEC | 3.1 |

TABLE 7B
Measurements of Full Cells (Effect of
Anode Loading in Full Cells with NCA)

| | | | 1^{st} | 1^{st} | |
|---|---|---|---|---|---|
| | 1^{st} | 1^{st} | Discharge | Charge | 1^{st} |
| | Discharge | Charge | Specific | Specific | Cycle |
| | Capacity | Capacity | Capacity | Capacity | Coulombic |
| Sample ID | (mAh) | (mAh) | (mAh/g) | (mAh/g) | Efficiency |
| A | 4.51 | 3.19 | 666 | 471 | 70.7% |
| B | 4.66 | 3.45 | 689 | 510 | 74.0% |
| C | 4.6 | 3.56 | 1030 | 797 | 77.4% |
| D | 4.35 | 3.46 | 974 | 775 | 79.5% |

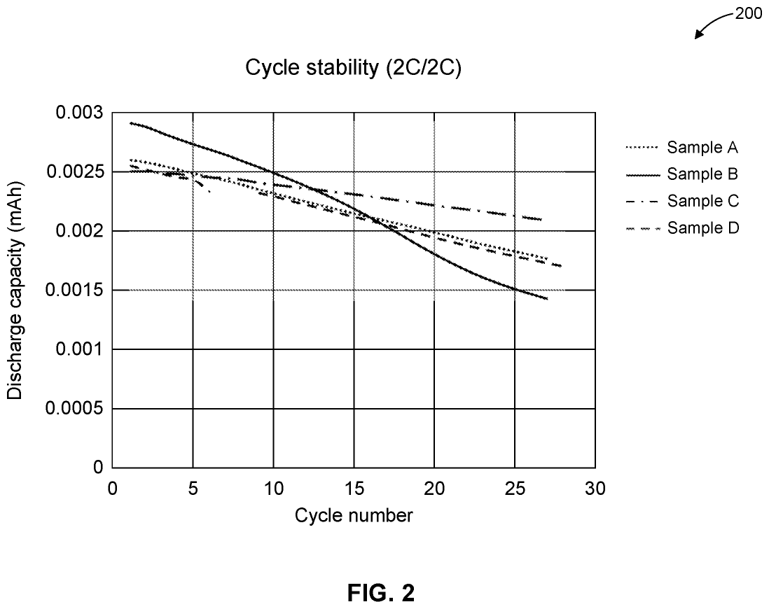

FIG. 2 shows a graph plot 200 of discharge capacity measurements versus number of discharge/charge cycles, according to some aspects. The electrode Samples A-D in graph plot 200 correspond to Samples A-D of Tables 7A and 7B, which were used as anodes. The cathode for the test was a nickel cobalt aluminum (NCA) electrode rated at a capacity of 2.5 mAh/cm².

In some aspects, the vertical axis of graph plot 200 represents a measured discharge capacity of the samples. The horizontal axis represents a number of discharge/charge cycles performed on the samples. Tests were performed at 2 C rates for both discharge and charge operations. Those skilled in the art will appreciate that testing can be performed at a given C rate. Those skilled in the art will appreciate a battery “C rate” or “C rating” relates to an energy storage device's charge and discharge rates when assessing its capacity. As a non-limiting example, C/10 can refer to a discharge test that spans 10 hours. Other C rates can be used for testing energy storage devices disclosed herein (e.g., C/20, 0.3 C, 1 C, or the like).

In some aspects, the data shows that higher active loading ratios of anode to cathode can mitigate discharge capacity loss and improve cycling stability (e.g., slower degradation of discharge capacity). For example, sample D exhibited the slowest degradation of discharge capacity among the samples.

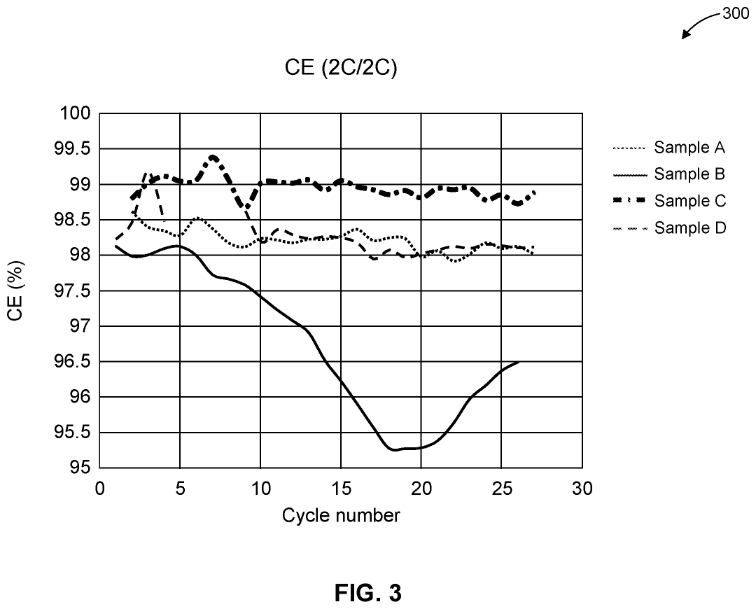

FIG. 3 shows a graph plot 300 of CE measurements versus number of discharge/charge cycles, according to some aspects. The Samples A-D in graph plot 300 correspond to Samples A-D of Tables 7A and 7B. The vertical axis represents a measured CE. The horizontal axis represents a number of discharge/charge cycles performed on the samples. The data shows that higher N/P ratios can mitigate CE loss and improve cycling stability (e.g., slower degradation of CE). For example, Sample D exhibited the highest CE among the samples, as well as the slowest degradation of CE.

In some aspects, electrolyte composition can also influence the effectiveness of different electrode types. For example, some electrode compositions can work better (or worse) with particular electrolyte compositions.

Tables 8A and 8B below show measured performance data for some of the compositions of anode 102 (or cathode 104) and electrolyte 106 to test the effects of electrolyte compositions, according to some aspects. The tests were performed in a full cell setup with the electrode compositions held constant (e.g., Si/graphite anodes (100 nm Si particle size) and the NCA cathode (2.5 mAh/cm²)). The electrolytes were polymer based using poly(ethylene glycol) methyl ether acrylate (MPEGA) and polyethylene glycol diacrylate (PEGDA) at a ratio of MPEGA/PEGDA 95/5 by weight.

TABLE 8A
Measurements of Electrolyte Compositions

| | Active |
|---|---|
| | Loading |
| Sample ID and Electrolyte Composition | (mg/cm²) |
| A: 1.2M LiPF6 in TEP/BTFE/FEC (1.2/0.13/4 mol) | 3.1 |
| B: 1M LiPF6 in DEC/FEC (4/1 wt.) | 3.1 |
| C: 1M LiPF6 in DMC/FEC/BTFE (70/10/20 wt.) | 3.1 |

TABLE 8B
Measurements of Electrolyte Compositions

| | | | 1^{st} | 1^{st} | |
|---|---|---|---|---|---|
| | 1^{st} | 1^{st} | Discharge | Charge | 1^{st} |
| | Discharge | Charge | Specific | Specific | Cycle |
| | Capacity | Capacity | Capacity | Capacity | Coulombic |
| Sample ID | (mAh) | (mAh) | (mAh/g) | (mAh/g) | Efficiency |
| A | 4.16 | 2.46 | 932 | 551 | 59.1% |
| B | 4.18 | 2.76 | 936 | 618 | 66.0% |
| C | 3.39 | 2.2 | 759 | 493 | 64.9% |

In some aspects, Sample A used 1.2M lithium hexafluorophosphate (LiPF6) in a mixture of triethyl phosphate (TEP), bis(2,2,2-trifluoroethyl) ether (BTFE), and fluoroethylene carbonate (FEC). Sample B used 1.2M LiPF6 in diethyl carbonate (DEC) and FEC. Sample C used 1.2M LiPF6 in dimethyl carbonate (DMC), FEC, and BTFE. The data in Tables 8A and 8B shows that samples with DEC (sample B) and DMC/FEC/BTFE (sample C) exhibited similar 1^{st} CE. It is to be appreciated that other compositions of MPEGA and PEGDA can be used, for example, 90-98% MPEGA and 2-10% PEGDA.

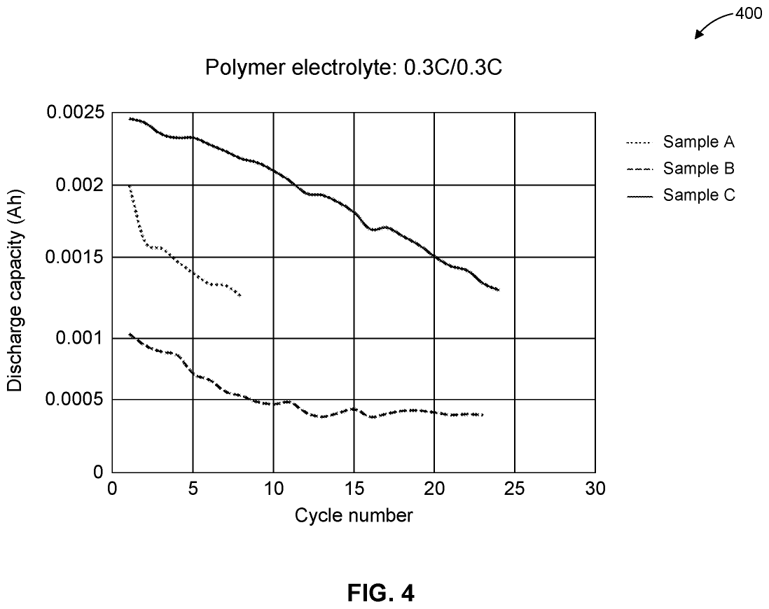

FIG. 4 shows a graph plot 400 of discharge capacity measurements versus number of discharge/charge cycles, according to some aspects. The electrolyte Samples A-C in graph plot 400 correspond to Samples A-C of Tables 8A and 8B. The vertical axis represents a measured discharge capacity of the samples. The horizontal axis represents a number of discharge/charge cycles performed on the samples. The cycle tests were performed at 0.3 C rates for the discharge and charge operations. In some aspects, Sample C exhibited a much higher capacity than the other two samples within the first 25 cycles.

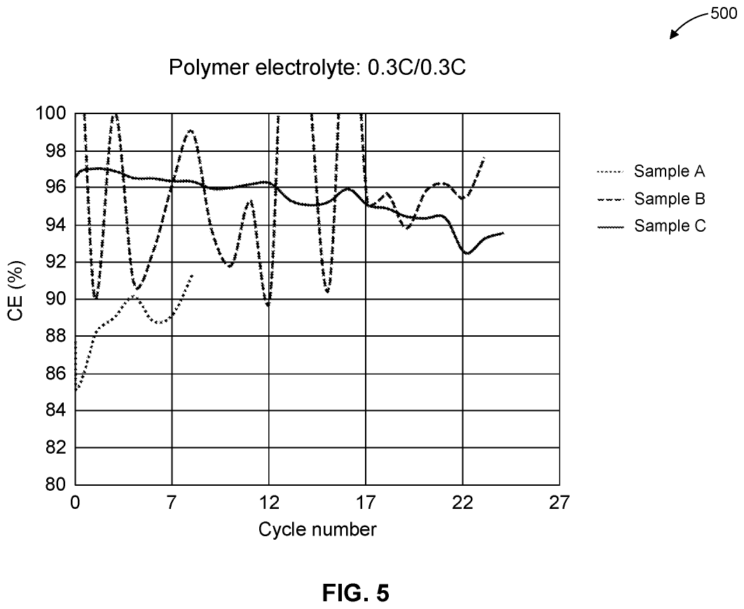

FIG. 5 shows a graph plot 500 of CE measurements versus number of discharge/charge cycles, according to some aspects. The electrolyte Samples A-C in graph plot 400 correspond to Samples A-C of Tables 8A and 8B. The vertical axis represents a measured CE of the samples. The horizontal axis represents a number of discharge/charge cycles performed on the samples. In some aspects, Sample C exhibited a high CE (e.g., above 90%) as well as good cycle stability.

While some of the aspects disclosed above implemented lithiated (lithium-neutralized) poly(acrylic acid) (PAL) binder, it should also be understood that poly(acrylic acid) implementations are not intended to be so limiting. In some aspects, any type of poly(acrylic acid) binder can be used, for example a “plain” (not-lithium-neutralized) poly(acrylic acid) (“PAA”).

Table 9 below shows measured a variety of electrode composition recipes used to make electrodes (e.g., anode 102) to test the effects of PAA, according to some aspects.

TABLE 9
Measurements of Electrode Compositions (Effect of Particle Size)

| | 50 μm | 100 μm | 150 μm |
|---|---|---|---|
| | Coating | Coating | Coating |
| | Active | Active | Active |
| Recipe ID and Electrode | Loading | Loading | Loading |
| Composition (by mass ratio) | (mg/cm²) | (mg/cm²) | (mg/cm²) |
| R1: 42.5% Si/32.5% graphite/10% | 0.88 | 1.47 | |
| C65/10% PAA/2.5% CMC/2.5% SBR | | | |
| R2: 42.5% Si/22.5% graphite/10% | 1.01 | | |
| C65/20% PAA/2.5% CMC/2.5% SBR | | | |
| R3: 37.5% Si/37.5% graphite/10% | 1.01 | 1.22 | |
| C65/10% PAA/2.5% CMC/2.5% SBR | | | |
| R4: 32.5% Si/32.5% graphite/10% | 1.01 | 1.29 | |
| C65/20% PAA/2.5% CMC/2.5% SBR | | | |
| R5: 60% Si/10% graphite/15% | 0.70 | 1.81 | 2.78 |
| C65/15% PAA | | | |
| R6: 60% Si/10% graphite/15% | 1.01 | 1.44 | |
| C65/10% PAA/2.5% CMC/2.5% SBR | | | |

In contrast to the tables before, Table 9 expresses recipe ID instead of sample ID since a variety of samples were fabricated from a given recipe. The recipes were formulated as pairs, so as to probe the effects of changing the percentage of PAA content while sacrificing a percentage of something else. For example, in the pair R1 and R2, R2 increases the PAA content by 10% while reducing graphite by 10%. In the pair R3 and R4, R4 increases PAA content by 10% while reducing both silicon and graphite content by 5%, respectively. In the pair R5 and R6, R5 increases the PAA content by 5% while removing CMC and SBR.

In some aspects, electrode samples varied in electrode layer coating thickness, for example, 50 μm, 100 μm, and 150 μm. A given electrode sample can be referred to by its recipe, construction type (half-cell or full cell), and coating thickness (e.g., R1 half-cell at 50 μm).

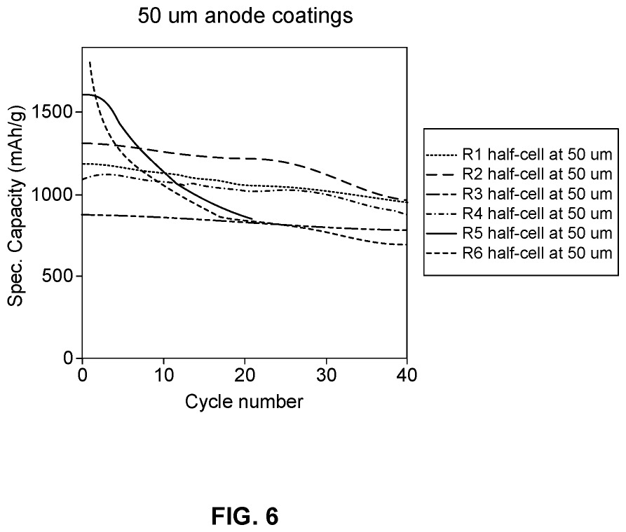

FIG. 6 shows a graph plot 600 of specific capacity measurements versus number of discharge/charge cycles, according to some aspects. Half-cell samples using recipes R1-R6 at 50 μm are shown. The vertical axis represents a measured specific capacity of electrode samples. The horizontal axis represents a number of discharge/charge cycles performed on the electrode samples. In some aspects, R1 half-cell at 50 μm, R3 half-cell at 50 μm, and R4 half-cell at 50 μm exhibited good cycle stability (e.g., a flat horizontal plot line with minimal decay over many cycles).

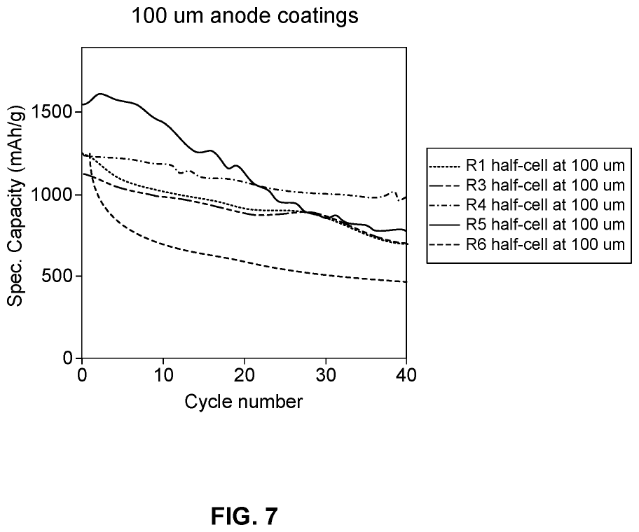

FIG. 7 shows a graph plot 700 of specific capacity measurements versus number of discharge/charge cycles, according to some aspects. Half-cell samples using recipes R1-R6 at 100 μm are shown. The vertical axis represents a measured specific capacity of electrode samples. The horizontal axis represents a number of discharge/charge cycles performed on the electrode samples. In some aspects, R4 half-cell at 100 μm exhibited good cycle stability. The data in FIGS. 6 and 7 show that R4 has a consistent cycle performance. R4 has a balanced silicon, graphite, and PAA composition (e.g., 32.5%, 32.5%, and 20%, respectively), compared to the other recipes.

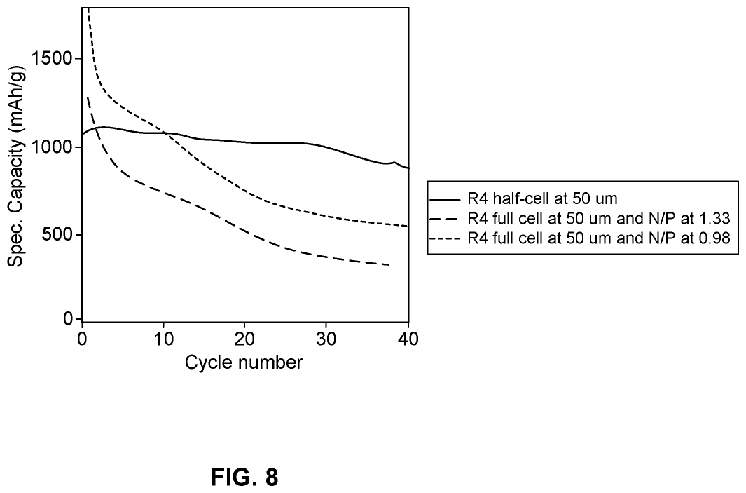

FIG. 8 shows a graph plot 800 of specific capacity measurements versus number of discharge/charge cycles for full cell samples, according to some aspects. Graph plot 800 is specifically directed to samples of R4 full cell at 50 μm. The vertical axis represents a measured specific capacity of electrode samples. The horizontal axis represents a number of discharge/charge cycles performed on the electrode samples. In some aspects, the performance of the full cell can be influenced by a ratio of the anode-to-cathode capacities (can also be referred to as N/P ratio or simply N/P). Therefore, graph plot 800 shows data for one sample of R4 full cell at 50 μm and N/P at 1.33 and another sample of R4 full cell at 50 μm and N/P at 0.98 (the cathode was made of lithium cobalt oxide (LCO)). Though graph plot 800 concerns full cells, a data plot for R4 half-cell at 50 μm is also shown (to provide a baseline comparison).

The steps of the methods disclosed herein can be performed in any conceivable order and it is not required that all steps be performed. Moreover, the method steps described herein merely reflect non-limiting based on the present disclosure. That is, a method is not limited to only those steps explicitly described. It should be appreciated that further method steps and functions are envisaged based on functions described in reference to aspects herein.

It is to be understood that the phraseology or terminology herein is for the purpose of description and not of limitation, such that the terminology or phraseology of the present disclosure is to be interpreted by those skilled in relevant art(s) in light of the teachings herein.

It is to be appreciated that the Detailed Description section, and not the Summary and Abstract sections, is intended to be used to interpret the claims. The Summary and Abstract sections can set forth one or more but not all exemplary aspects of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

While specific aspects of the disclosure have been described above, it will be appreciated that aspects of the present disclosure can be practiced otherwise than as described. The descriptions are intended to be illustrative, not limiting. Thus it will be apparent to one skilled in the art that modifications can be made to the disclosure as described without departing from the scope of the claims set out below.

The foregoing description of the specific aspects will so fully reveal the general nature of the present disclosure that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein.

The breadth and scope of the protected subject matter should not be limited by any of the above-described exemplary aspects, but should be defined only in accordance with the following claims and their equivalents.

What is claimed is:

1. An energy storage device comprising:
a cathode;
an anode comprising:
a support structure; and
an electrode layer disposed on the support structure, the electrode layer comprising:
40-80% silicon;
15-40% graphite;
5-15% carbon black;
0-15% carboxymethyl cellulose (CMC);
0-5% styrene-butadiene rubber (SBR); and
5-20% poly(acrylic acid);
a separator disposed between the anode and cathode to prevent internal shorting of the energy storage device; and
an electrolyte configured to allow movement of ions between the anode and cathode.

2. The energy storage device of claim 1, wherein:
the 40-80% silicon is 42.5% silicon;
the 15-40% graphite is 32.5% graphite;
the 5-15% carbon black is 10% carbon black;
the 0-15% CMC is 2.5% CMC;
the 0-5% SBR is 2.5% SBR; and
the 5-20% poly(acrylic acid) is 10% lithium-neutralized poly(acrylic acid) (PAL).

3. The energy storage device of claim 1, wherein:
the 40-80% silicon is 32.5% silicon;
the 15-40% graphite is 32.5% graphite;
the 5-15% carbon black is 10% carbon black;
the 0-15% CMC is 2.5% CMC;
the 0-5% SBR is 2.5% SBR; and
the 5-20% poly(acrylic acid) is 20% non-lithium-neutralized poly(acrylic acid) (PAA).

4. The energy storage device of claim 1, wherein the electrolyte is a polymer electrolyte comprising:
90-98% poly(ethylene glycol) methyl ether acrylate (MPEGA); and
2-10% polyethylene glycol diacrylate (PEGDA); and
lithium hexafluorophosphate (LiPF6) prepared in a mixture comprising:
bis(2,2,2-trifluoroethyl) ether (BTFE); and
at least one of:
ethylene carbonate (EC);
dimethyl carbonate (DMC);
diethyl carbonate (DEC);
triethyl phosphate (TEP); and
fluoroethylene carbonate (FEC).

5. The energy storage device of claim 4, wherein the mixture comprises the DMC, FEC, and BTFE.

6. The energy storage device of claim 5, wherein the DMC, FEC, and BTFE have a ratio of approximately 70%, 10%, and 20%, respectively.

7. The energy storage device of claim 1, wherein an active loading rate corresponding to the 40-80% silicon and 15-40% graphite is approximately 1-5 mg/cm².

8. The energy storage device of claim 1, wherein the 40-80% silicon is structured as fine particles having an average size of approximately 3 μm or less.

9. The energy storage device of claim 1, wherein the 40-80% silicon is structured as fine particles having an average size of approximately 100 nm or less.

10. The energy storage device of claim 1, wherein a Coulombic efficiency of the energy storage device is approximately 90% or greater over approximately 25 charge and discharge cycles or more.

11. An electrode comprising:
a support structure; and
an electrode layer disposed on the support structure, the electrode layer comprising:
40-80% silicon;
15-40% graphite;
5-15% carbon black;
0-15% carboxymethyl cellulose (CMC);
0-5% styrene-butadiene rubber (SBR); and
5-20% poly(acrylic acid).

12. The electrode of claim 11, wherein:
the 40-80% silicon is 42.5% silicon;
the 15-40% graphite is 32.5% graphite;
the 5-15% carbon black is 10% carbon black;
the 0-15% CMC is 2.5% CMC;
the 0-5% SBR is 2.5% SBR; and
the 5-20% poly(acrylic acid) is 10% lithium-neutralized poly(acrylic acid) (PAL).

13. The electrode of claim 11, wherein:
the 40-80% silicon is 32.5% silicon;
the 15-40% graphite is 32.5% graphite;
the 5-15% carbon black is 10% carbon black;
the 0-15% CMC is 2.5% CMC;
the 0-5% SBR is 2.5% SBR; and
the 5-20% poly(acrylic acid) is 20% non-lithium-neutralized poly(acrylic acid) (PAA).

14. The electrode of claim 11, wherein an active loading rate corresponding to the 40-80% silicon and 15-40% graphite is approximately 1-5 mg/cm²

15. The electrode of claim 11, wherein the 40-80% silicon is structured as fine particles having an average size of approximately 3 μm or less.

16. The electrode of claim 11, wherein the 40-80% silicon is structured as fine particles having an average size of approximately 100 nm or less.

17. A polymer electrolyte comprising:
90-98% poly(ethylene glycol) methyl ether acrylate (MPEGA); and
2-10% polyethylene glycol diacrylate (PEGDA); and
lithium hexafluorophosphate (LiPF6) prepared in a mixture comprising:
bis(2,2,2-trifluoroethyl) ether (BTFE); and
at least one of:
ethylene carbonate (EC);
dimethyl carbonate (DMC);
diethyl carbonate (DEC);
triethyl phosphate (TEP); and
fluoroethylene carbonate (FEC).

18. The polymer electrolyte of claim 17, wherein the mixture comprises the DMC, FEC, and BTFE.

19. The polymer electrolyte of claim 17, wherein the DMC, FEC, and BTFE have a ratio of approximately 70%, 10%, and 20%, respectively.
